(19) United States
(12) Patent Application Publication
(10) Pub. No.: US 2018/0083876 A1
(43) Pub. Date: Mar. 22, 2018

(54) OPTIMIZATION OF MULTI-TABLE LOOKUPS FOR SOFTWARE-DEFINED NETWORKING SYSTEMS

(71) Applicant: Radisys Corporation, Hillsboro, OR (US)

(72) Inventors: Prashant Sharma, San Diego, CA (US); Andrew Alleman, Portland, OR (US); Srinivas Sadagopan, Bangalore (IN); Prathap Thammanna, Bangalore (IN)

(21) Appl. No.: 15/710,452

(22) Filed: Sep. 20, 2017

Related U.S. Application Data
(60) Provisional application No. 62/397,291, filed on Sep. 20, 2016.

(51) Int. Cl. H04L 12/741; H04L 12/721

(52) U.S. Cl. CPC H04L 45/745; H04L 45/64; H04L 45/54; H04L 45/38

(57) ABSTRACT

To optimize the multi-table search process, the present disclosure defines a method in which searching across multiple OpenFlow tables is consolidated into searching across a set of three distinct flow caches called access control, application, and forward flow caches. Each OpenFlow table is mapped into one of these flow caches based on the size of the table and whether it contains flows of different priority. The mapping rule ensures that large (in terms of number of entries) OpenFlow tables with no conflicting priority rules are mapped to a flow cache. The disclosed techniques reduce the number of searches and, at the same time, selectively avoid a costly process of revalidation of entries in the flow cache when new higher-priority flows are added by the SDN controller.

### RELATED APPLICATION

This application claims the benefit of U.S. Provisional Patent Application No. 62/397,291, filed Sep. 20, 2016, which is hereby incorporated by reference herein in its entirety.

### TECHNICAL FIELD

This disclosure relates generally to software-defined networking (SDN) and, more particularly, to optimization of a multi-table lookup.

### BACKGROUND INFORMATION

In packet switching networks, traffic flow, (data) packet flow, network flow, datapath flow, work flow, or (simply) flow is a sequence of packets, typically of an internet protocol (IP), conveyed from a source computer to a destination, which may be another host, a multicast group, or a broadcast domain. Request for Comments (RFC) 2722 defines traffic flow as “an artificial logical equivalent to a call or connection.” RFC 3697 defines traffic flow as “a sequence of packets sent from a particular source to a particular unicast, anycast, or multicast destination that the source desires to label as a flow. A flow could consist of all packets in a specific transport connection or a media stream. However, a flow is not necessarily 1:1 mapped to a transport connection [i.e., under a Transmission Control Protocol (TCP)].” Flow is also defined in RFC 3917 as “a set of IP packets passing an observation point in the network during a certain time interval.” In other words, a work flow comprises a stream of packets associated with a particular application running on a specific client device, according to some embodiments.

Radisys Corporation of Hillsboro, Oreg. has developed the FlowEngine™ product line characterized by a network element—e.g., a firewall, load balancer (LB), gateway, or other computer networking devices (including virtualized devices)—having a high throughput and optimized implementation of a packet datapath, which is also called a forwarding path. Additional details of the FlowEngine concept are described in a Radisys Corporation white paper titled “Intelligent Traffic Distribution Systems,” dated May 2015.

### SUMMARY OF THE DISCLOSURE

This disclosure describes techniques to optimize a multi-table lookup process in order to achieve high performance in terms of datapath packet throughput. The disclosed technology also addresses scalability limitations of the previous multi-table lookup attempts by mitigating cache thrashing (i.e., streamlining cache revalidation) while calculating packet and flow statistical information in real time.

To optimize a multi-table search process, the present disclosure describes a paradigm in which a search across multiple flow (e.g., OpenFlow) tables is consolidated into a search across a set of three discrete flow caches called an access control flow cache, an application flow cache, and a forward flow cache, each of which stores active-flow information from certain corresponding flow tables. Thus, the technique of this disclosure groups flow table information into three different classes, and active rules of these classes are stored in the appropriate flow caches. This makes it possible to isolate cache thrashing problems arising from information from certain tables so as to eliminate cache thrashing for unrelated groups of tables that do not have priority-based rule conflicts. The reduction in thrashing reduces processor utilization and allows the present embodiments to dramatically scale up the number of active flows that are serviceable.

According to one embodiment, each flow table is mapped onto one of the flow caches based on the size of the flow table and whether it contains flows of different priorities. For example, according to some embodiments, priority-based rules are isolated in the access control flow cache and large (i.e., in terms of number of entries) flow tables with no conflicting priority rules are mapped to, e.g., the application flow cache. Thus, an addition of higher-priority rules in the access control flow cache—e.g., through modification of the corresponding flow table, which is then propagated to cache—may still result in revalidation of the access control flow cache, but the large number of rules cached in the application and forward flow caches are unaffected.

For many wireline/wireless applications, tables mapped to the access control flow cache typically contain on the order of thousands of rules that are not changed frequently, whereas the application flow cache may contain many millions of rules that are added or deleted frequently. Thus, isolating the application flow cache entries from cache revalidation is an advantage of the disclosed embodiments.

The disclosed techniques also reduce the number of searches and, at the same time, selectively avoid a costly process of revalidation of entries in the flow caches when new higher-priority flows are added by an SDN controller.

This disclosure also contemplates various use cases for network devices implementing service function chaining (SFC), carrier-grade network address translation (CGNAT), load balancing, wireline and wireless service gateways, firewalls, and other functions and associated embodiments.

Additionally, in terms of statistics optimization, since the datapath maintains statistics for each rule, statistics requests are available directly without processor-intensive collation of statistics from different cached rules.

Additional aspects and advantages will be apparent from the following detailed description of embodiments, which proceeds with reference to the accompanying drawings.

### BRIEF DESCRIPTION OF THE DRAWINGS

FIG. 1 is a block diagram showing an overview of FIGS. 1A and 1B.

FIGS. 1A and 1B are block diagrams collectively showing an example SDN datapath function.

FIG. 2 is a block diagram of an Open vSwitch (OVS) datapath implementation.

FIG. 3 is a block diagram of an OVS implementation of the prior art for illustrating problems with cache thrashing and cache pollution.

FIG. 4 is an annotated block diagram showing a grouping of tables into discrete flow caches, according to one embodiment.

FIG. 5 is a block diagram showing a hardware accelerated version of the datapath of FIG. 2, including multiple flow caches, according to one embodiment.

### DETAILED DESCRIPTION OF EMBODIMENTS

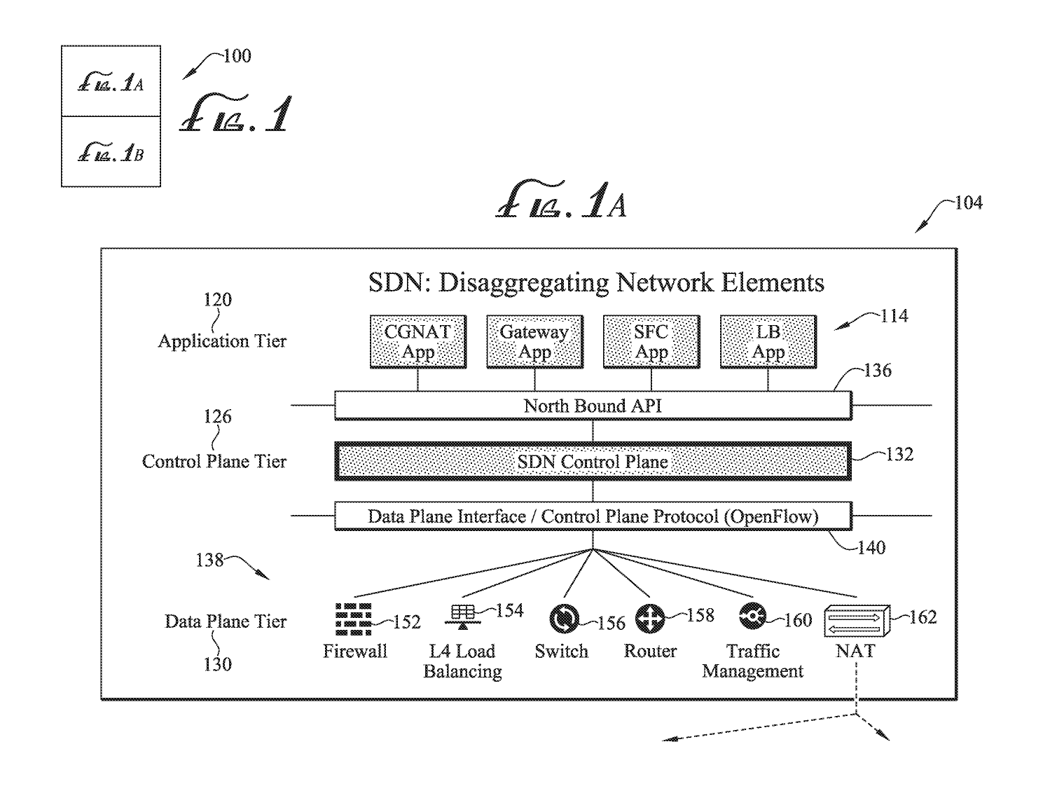

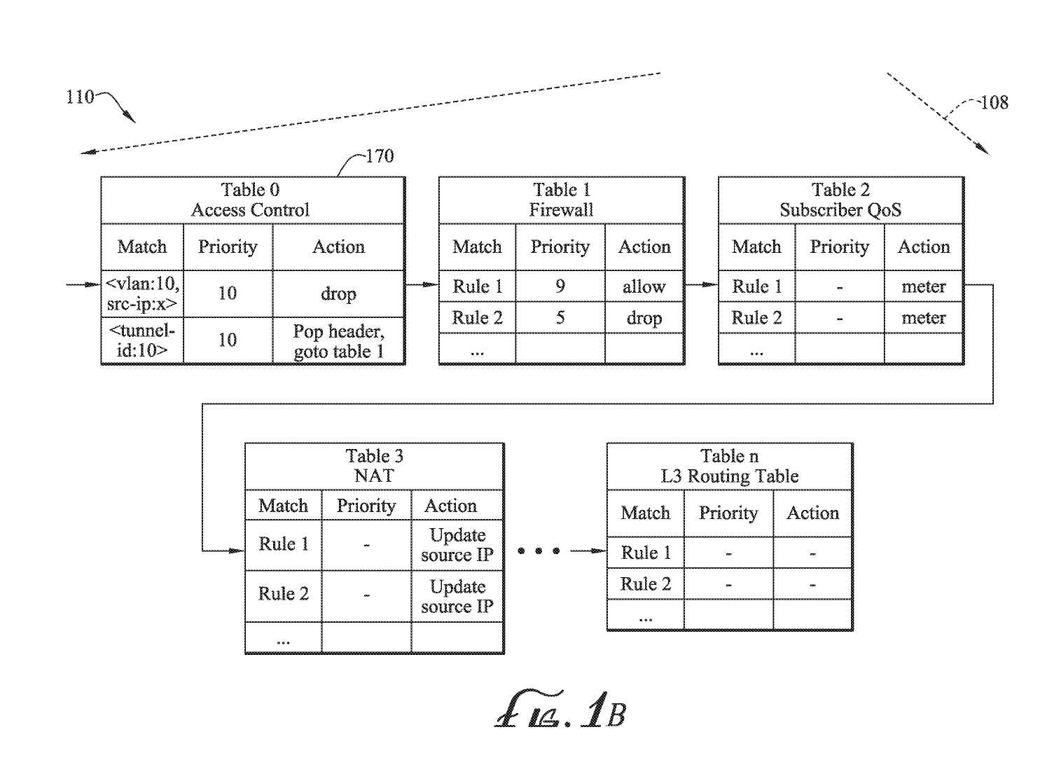

FIG. 1 is an overview 100 of the arrangement of FIGS. 1A and 1B, which collectively show an example SDN datapath function. Specifically, FIG. 1A shows an example SDN block diagram 104. A datapath function 108 for SDN is defined by a table pipeline 110 shown in FIG. 1B. A pipeline is a set of linked flow tables that provide matching, forwarding, and packet modification in an SDN device.

SDN addresses the fact that a monolithic architecture of traditional networks does not support the dynamic, scalable computing and storage needs of more modern computing environments, such as data centers. For example, as shown in FIG. 1A, SDN is an approach to computer networking that allows network administrators to readily deploy network applications 114 defining an application tier 120 by management, through higher-level abstraction of network services in a control plane tier 126, of lower-level infrastructure functionality provided in a data plane tier 130. The network applications 114 are communicatively coupled to an SDN control plane 132 (i.e., the system that makes decisions about where traffic is sent) through a northbound application programming interface (API) 136, and the SDN control plane 132 is communicatively coupled to a datapath 138 (i.e., the part of a network element that carries user traffic and forwards it to the selected destination, also known as the user plane, forwarding plane, carrier plane, bearer plane, or data plane) through a data plane interface 140. Thus, SDN logically separates the control plane 132 from a physical network topology to create an environment in which firewalls 152, load balancers 154, switches 156, routers 158, traffic management devices 160, network address translation (NAT) devices 162, and other network devices take traffic forwarding cues from a centralized management controller so as to decouple, disassociate, or disaggregate the SDN control plane 132 from the datapath 138.

The firewalls 152 are devices that you use to separate a safe internal network from the internet. The load balancers 154 divide work between two or more servers in a network. The load balancers 154 are used to ensure that traffic and central processing unit (CPU) usage on each server is as well-balanced as possible. The switches 156 are devices that provide point-to-point inter-connections between ports and can be thought of as a central component of a network. The routers 158 are devices that can route one or more protocols, such as TCP/IP, and bridge all other traffic on the network. They also determine the path of network traffic flow. The traffic management devices 160 are used by network administrators to reduce congestion, latency, and packet loss by managing, controlling, or reducing the network traffic. The NAT devices 162 remap one IP address space into another by modifying network address information in IP datagram packet headers while they are in transit across a traffic routing device.

A datapath function is essentially a sequence of table lookups and related actions defined in a set of tables. For example, with reference to FIG. 1B, each table includes a set of rules for flows, in which each rule includes packet match fields and associated actions. Accordingly, a match process starts in a first table 170 by selecting a highest priority matching entry and, depending on the result, continues on to the next tables in the pipeline 110.

To define the functional behavior imparted by the tables, a communication protocol such as OpenFlow allows remote administration of, e.g., a layer 3 switch's packet forwarding tables, by adding, modifying, and removing packet matching rules and actions for the purpose of defining the path for network packets across a network of switches. In other words, a control plane protocol, such as OpenFlow, defines a packet datapath function in terms of a sequence of lookup or action tables, i.e., each with many rules for controlling flows. Since the emergence of the OpenFlow protocol in 2011, it has been commonly associated with SDN. A conventional pipeline defined in OpenFlow (version 1.2 and higher) employs multiple flow tables, each having multiple flow entries and their relative priority.

A table pipeline defines logical behavior, but there are several options for the actual datapath implementation.

The first option is to map (i.e., one-to-one mapping) a flow table to a corresponding table in silicon, i.e., memory, such as dynamic random-access memory (DRAM). This approach is highly inefficient due to multi-table lookups. This approach also does not take advantage of the fact that all packets in a flow may be subject to the same treatment.

The second option is to create one table that is a union of all flow table rules. This approach results in a massive table that suffers from scalability problems as the number of combined tables and rules grows. This approach also has significant overhead during rule addition or deletion due to the size of the table.

The third option is to create a rule cache for active flows. A rule cache is a hardware or software component that stores data (active flows) so future requests for that data can be served faster; the data stored in a cache might be the result of an earlier computation, or the duplicate of data stored elsewhere. A cache hit occurs when the requested data can be found in a cache, while a cache miss occurs when it cannot. Cache hits are served by reading data from the cache, which is faster than re-computing a result or reading from a slower data store; thus, the more requests can be served from the cache, the faster the system performs.

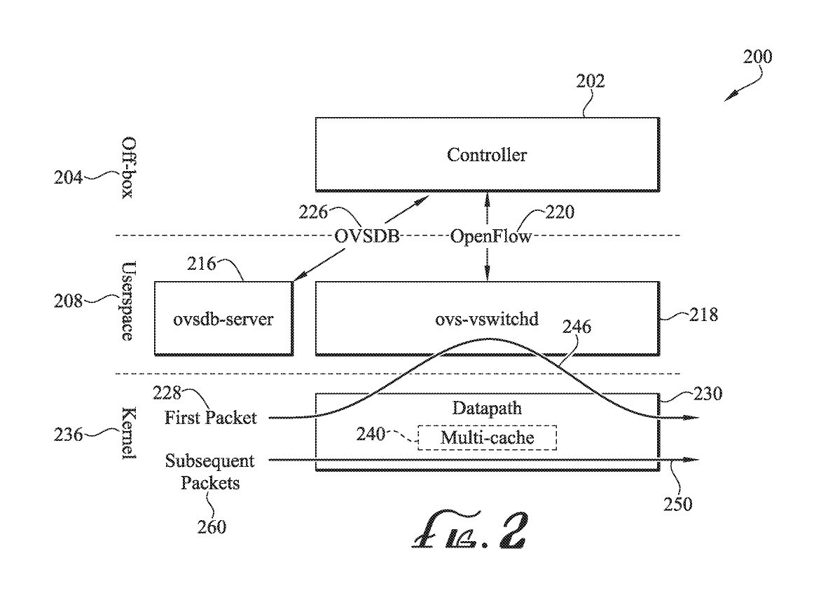

The rule-caching approach is used by popular open source solutions like Open vSwitch 200, sometimes abbreviated as OVS, which is a software switch represented by FIG. 2. In FIG. 2, a controller 202 is located off-box 204, i.e., separate, from userspace 208 components including ovsdb-server 216 and ovs-vswitchd 218. In some embodiments the controller 202 generates control plane protocol messages and communicates—e.g., by TCP, user datagram protocol (UDP), stream control transmission protocol (SCTP), or other communications—them to the userspace 208 at which point the messages are processed and translated into rules and actions stored in an OpenFlow pipeline (and ultimately deployed in cache). Specifically, the ovs-vswitchd 218 is a userspace daemon responsible for storing the OpenFlow pipeline and facilitating OpenFlow command communications 220 with the controller 202, which interfaces with the ovsdb-server 216 for accessing OVSDB configuration and management data 226. The ovs-vswitchd 218 also provides interfaces to ports on different operating systems, physical switch silicon, or other interfaces involved in the datapath.

When a first packet 228 is received by a kernel datapath module 230 in kernel space 236, multi-cache 240 (e.g., one or more cache devices) including multiple flow caches is consulted. For example, the first packet 228 is passed to internal_dev_xmit( ) to handle the reception of the packet from the underlying network interface. At this point, the kernel datapath module 230 determines from its flow caches whether there is a cached rule (i.e., active-flow information) for how to process (e.g., forward) the packet 228. This is achieved through a function that includes a key (parameter) as its function argument. The key is extracted by another function that aggregates details of the packet 228 (L2-L4) and constructs a unique key for the flow based on these details.

If there is no entry, i.e., no match is found after attempting to find one, the packet 228 is sent to the ovs-vswitchd 218 to obtain instructions for handling the packet 228. In other words, when there is not yet a cached rule accessible to the kernel 236, it will pass the first packet 228 to the userspace 208 via a so-called upcall( ) function indicated by curved line 246.

The ovs-vswitchd 218 daemon checks the database and determines, for example, which is the destination port for the first packet 228, and instructs the kernel 236 with OVS_ACTION_ATTR_OUTPUT as to which port it should forward to (e.g., assume eth0). Skilled persons will appreciate that the destination port is just one of many potential actions that can be provisioned in an OpenFlow pipeline. More generally, the ovs-vswitchd 218 checks the tables in an OpenFlow pipeline to determine collective action(s) associated with flow. Example of potential actions include determining destination port, packet modification, dropping or mirroring packet, quality of service (QoS) policy actions, or other actions.

An OVS_PACKET_CMD_EXECUTE command then permits the kernel 236 to execute the action that has been set. That is, the kernel 236 executes its do_execute_actions( ) function so as to forward the first packet 228 to the port (eth0) with do_output( ). Then the packet 228 is transmitted over a physical medium. More generally, the ovs-vswitchd 218 executes an OpenFlow pipeline on the first packet 228 to compute the associated actions (e.g., modify headers or forward the packet) to be executed on the first packet 228, passes the first packet 228 back to a fastpath 250 for forwarding, and installs entries in flow caches so that similar packets will not need to take slower steps in the userspace 208.

In the rule-cache approach, when a new flow is detected, its initial packet is passed through a complete pipeline, and a consolidated rule (match and action) is added in the cache 240. If a relevant flow cache entry is found, then the associated actions (e.g., modify headers or forward or drop the packet) are executed on the packet as indicated by the fastpath 250. Subsequent packets 260 of the flow are then handled based on the entry in the cache 240 rather than being passed through the complete pipeline (i.e., a simpler lookup).

Skilled persons will appreciate that receiving actions are similar to transmitting. For example, the kernel module for OVS registers an rx_handler for the underlying (non-internal) devices via the netdev_frame_hook( ) function. Accordingly, once the underlying device receives packets arriving through a physical transmission medium, e.g., through the wire, the kernel 236 will forward the packet to the userspace 208 to check where the packet should be forwarded and what actions are to be executed on the packet. For example, for a virtual local area network (VLAN) packet, the VLAN tag is removed from the packet and the modified packet is forwarded to the appropriate port.

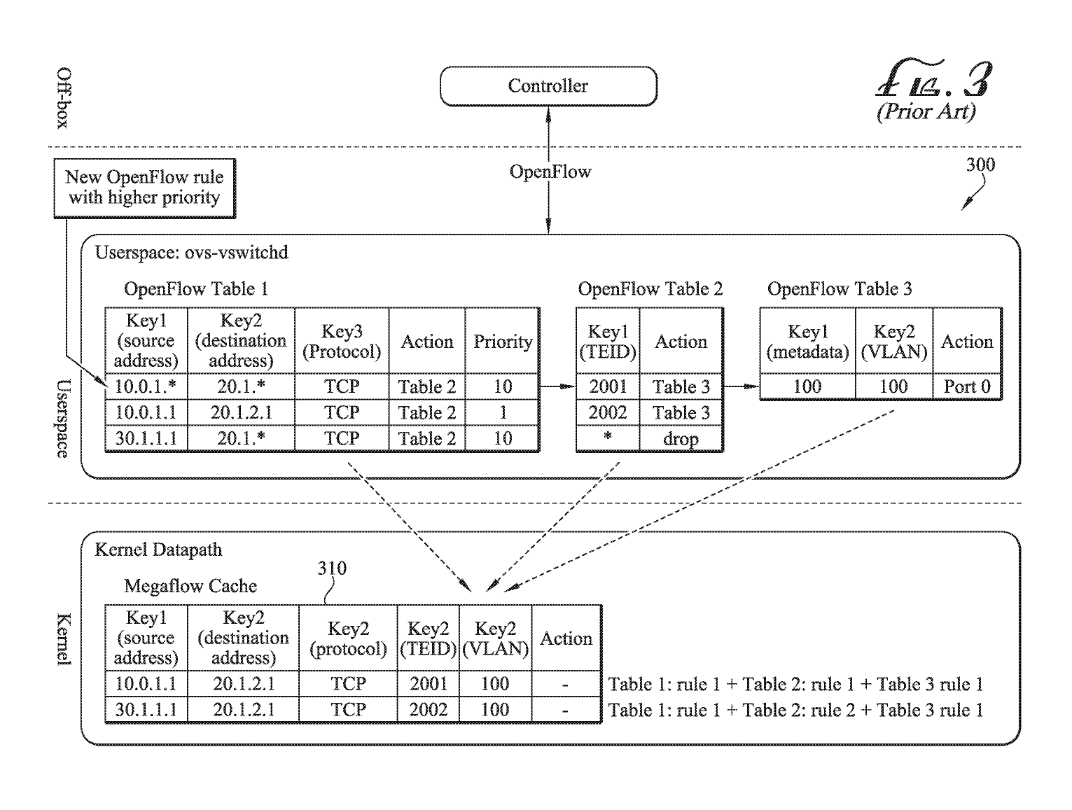

The rule-caching paradigm decreases the time for a multi-table lookup sequence by creating a cache of active flows and related rules. But in previous attempts, as shown in an OVS 300 of FIG. 3, a single cache 310 included multiple cached rules, each of which was a superset of a matched rule in each flow table. Unlike multi-cache 204 (FIG. 2), the single cache 310 is prone to cache thrashing (i.e., eviction of useful data) when higher-priority rules (i.e., higher than the one present in cache) were added or deleted in userspace flow tables. Accordingly, several challenges arose in connection with the aforementioned rule-caching attempts. The issues generally concern cache thrashing and cache pollution, which manifest themselves during three scenarios: addition of a rule, recovery of rule statistics, and deletion of a rule, which are explained as follows.

First, challenges arise when conflicting priority rules are added by a control plane entity. For example, the addition of a high-priority rule may entail a purge of previously cached entries. Suppose there exists the following low-priority rule in cache:

TABLE 1
Flow Table X

| Rule | Priority |
|---|---|
| <source-ip = 10.0.1.1, destination-ip = 20.1.2.1, | priority 1 |
| TEID = 2001, VLAN = 100> | |

If an SDN controller were to now add a following conflicting higher-priority rule in one of the flow tables, but the foregoing existing rule in cache is not purged, then certain flows would continue to match to lower priority rule in cache and result in undesired action for packet. This is known as the cache thrashing problem. One way to solve the problem is to revalidate cache every time (or periodically) rules are added in flow tables.

TABLE 2
Flow Table X

| Rule | Priority |
|---|---|
| <source-ip = 10.0.1.x, destination-ip = 20.1.*> | priority 10 |

In some OVS embodiments supporting megaflows, the kernel cache supports arbitrary bitwise wildcarding. In contrast, microflows contained exact-match criteria in which each cache entry specified every field of the packet header and was therefore limited to matching packets with this exact header. With megaflows, it is possible to specify only those fields that actually affect forwarding. For example, if OVS is configured simply to be a learning switch, then only the ingress port and L2 fields are relevant, and all other fields can be wildcarded. In previous releases, a port scan would have required a separate cache entry for, e.g., each half of a TCP connection, even though the L3 and L4 fields were not important.

As alluded to previously, the OVS implementation is prone to cache thrashing when a higher-priority rule is added by controller. This is true even if only one of the tables in the chain allows priority rule. In other words, as long as one table has a priority-based flow rule, then there is a potential for a thrashing problem. But the implementation in OVS to handle this discrepancy is rudimentary. It periodically pulls all cached rules and matches them against an existing rules database, and removes conflicting rules. This process has a practical limitation of 200 k-400 k cache entries and therefore does not scale well for millions of flows in cache. There is also an undue delay before the new rule takes effect.

Second, OpenFlow rule statistics also entail special handling. For example, a megaflow cache consolidates many entries of flow tables into one table as a cross-section of active flow table rules. As such, one OpenFlow rule can exist as part of more than one cached entry. Due to performance reasons, statistics are kept along with megaflow cached entries. When the SDN controller asks for OpenFlow rule statistics, one needs to read all cached entries to which the requested OpenFlow rule belongs. The implementation in OVS to handle this statistic-information recovery is also rudimentary. It periodically pulls all cached rules and matches them against the existing rules database, and updates OpenFlow rule statistics. This process does not scale for millions of flows in cached entries, and there is delay before statistics are updated.

Third, another issue arises in connection with OpenFlow rule deletion. Essentially, the implementation attempts to determine the set of cached rules to be deleted. Thus, the same problem as described previously also exists during OpenFlow rule deletion.

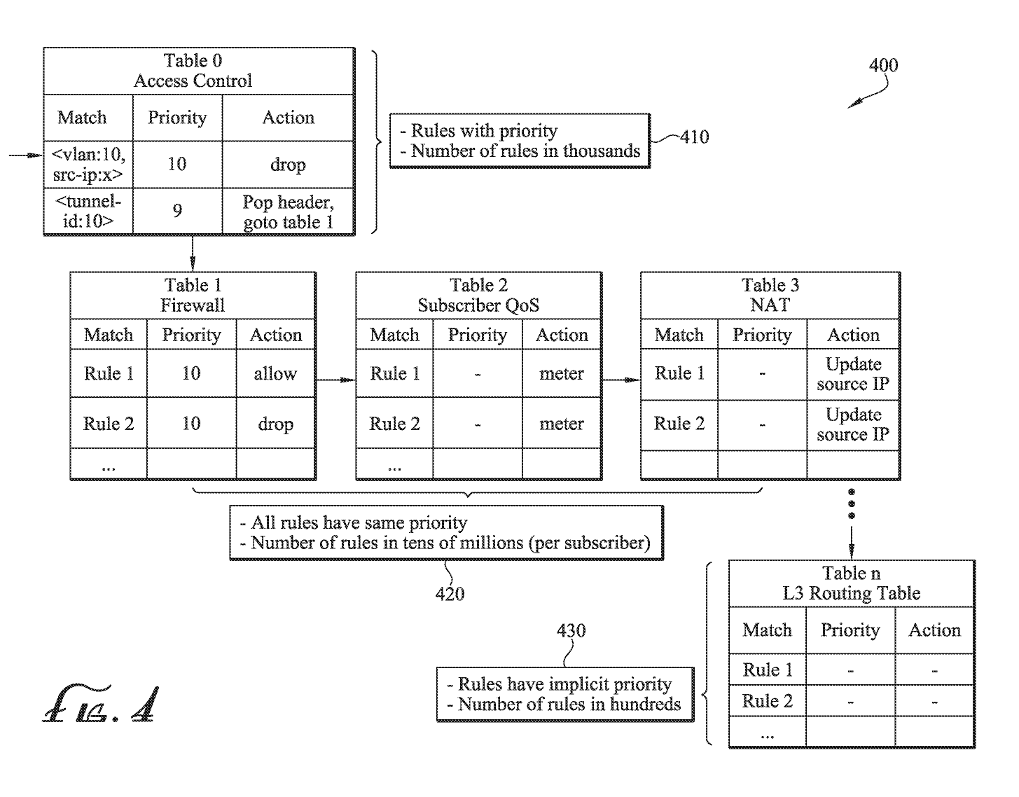

FIG. 4 shows how a table pipeline 400 is groupable to realize an improved datapath implementation. This improved datapath implementation is suitable for various wireless/wireline domain use cases such as CGNAT, load balancer, service gateway, service function chaining, and other uses. In general, flow tables are grouped according to the following three categories; and the solution entails creating unique cache for each group of flow tables.

One or more first flow tables 410 are referred to as access control flow tables. The access control flow tables 410 are specified by generic OpenFlow match criteria. Match fields can be maskable (e.g., an IP address is 32 bit, in which case a portion is masked to match only the first several bits) and individual rules can have a priority. Examples of such tables include flow tables to filter incoming packets. More specifically, FIG. 4 shows a single access control list (ACL) flow table 410.

Following the access control flow tables 410, one or more second flow tables 420 are referred to as application flow tables. The application flow tables 420 are characterized by all rules sharing a common priority and a relatively large number of entries, on the order of ones to tens of millions of entries. For typical systems, the application tables may have one million to forty million entries per subscriber. Subscriber here means end users like mobile phones, laptops, or other devices. A “per subscriber rule” means that unique rules are created for each subscriber depending upon what they are doing, e.g., Facebook chat, Netflix movie steam, browsing, or other internet-centric activities. In some embodiments, there is at least one rule for each application that a subscriber is using, and such rules have corresponding action(s) describing what actions be taken for flow, e.g., rate limit Netflix stream at peak time. Operators support millions of subscribers and hence the number of rules here can be very large. Also, for a given rule, the match fields can be maskable. An example of such a flow table includes a stateful load balancer table, classifier, service function forwarder, subscriber tunnel table, or similar types of tables. More specifically, FIG. 4 shows a set of application flow tables 420 including a firewall flow table, a subscriber QoS flow table, and a NAT flow table.

Following the application flow tables 420, one or more third flow tables 430 are referred to as forward flow tables. The forward flow tables 430 are characterized by rules that match based on a prefix of a field of the packet (e.g., longest prefix match, LPM). The rules of these flow tables have no explicit priority, but it is assumed that there is an implicit priority due to the longest prefix. An example of such a forward table includes a route entry table. More specifically, FIG. 4 shows a single forward flow table 430 that is the L3 routing flow table.

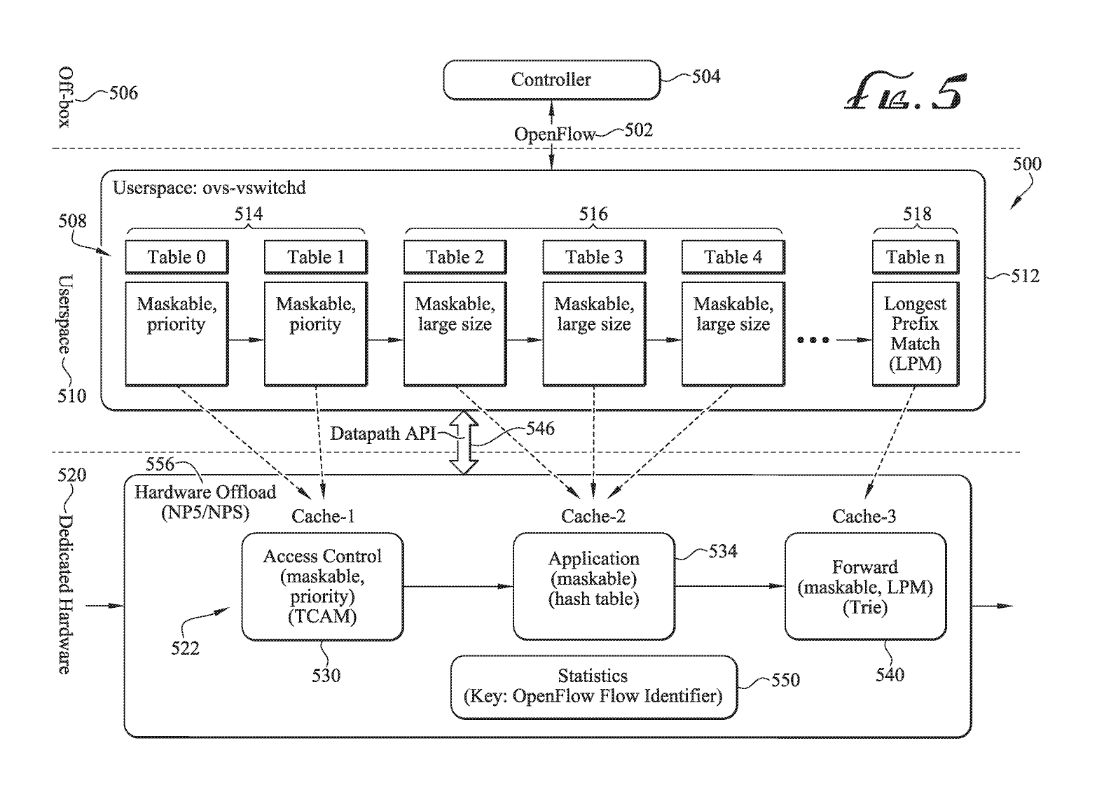

FIG. 5 shows a computer networking device 500 for SDN that is administrable with a control plane protocol, such as OpenFlow 502. For example, a controller 504 located off-box 506 (or away from the computer networking device 500) provides OpenFlow commands to configure multiple flow tables 508 in userspace 510 to control the handling of a packet according to a datapath function that is configurable through the control plane protocol.

According to one embodiment, the computer networking device 500 includes a memory (e.g., DRAM) 512 to store the multiple flow tables 508. A memory device may also include any combination of various levels of non-transitory machine-readable memory including, but not limited to, read-only memory (ROM) having embedded software instructions (e.g., firmware), random access memory (e.g., DRAM), cache, buffers, etc. In some embodiments, memory may be shared among various processors or dedicated to particular processors.

The multiple flow tables 508 include a pipeline (i.e., progression or sequence) of first 514, second 516, and third 518 flow tables. The first flow table 514, which may include one or more tables, includes first rules of different priorities. The second flow table 516, which may include one or more tables, includes second rules sharing a common priority. The third flow table 518, which may include one or more tables, includes third rules that are matchable based on a prefix of a field of the packet.

In hardware 520, multiple flow caches 522 are provided. Note that a flow cache corresponds to the cached active-flow information of one or more flow tables, but need not include a physically discrete cache device. In other words, there may be one cache (device) including one or more flow caches.

According to some embodiments, first (access control) 530, second (application) 534, and third (forward) 540 flow caches store active-flow information of the first 514 (access control), second 516 (application), and third 518 (forward) flow tables, respectively (as pointed by dashed lines). Thus, there is one flow cache for each distinct group of tables. And priority conflicts on one group do not result in cache thrashing on other groups. Table groups having millions of entries with no conflicting priority are immune to cache thrashing.

The active-flow information is the rules and actions that apply to a packet or flow. These rules are cached using a datapath API 546 that facilitates writing to different cache devices. As indicated in the previous paragraph, some embodiments include a common physical cache memory that has logically separated segments corresponding to the three flow caches 522. FIG. 5, however, shows a ternary content-addressable memory (TCAM) for the first (access control) flow cache 530, a hash table for the second (application) flow cache 534, and a trie (digital tree) for the third (forward) 540 flow cache. Thus, notwithstanding different physical or logical implementations for cache, the datapath API 546 provides for adding and deleting rules and actions and recovering statistics 550.

To facilitate statistics-information recovery and delete operations, each flow table rule has a unique identifier. Likewise, all cached rules have unique identifiers. As packets hit the caches, statistics for corresponding rules are updated in real time, resulting in predictable recovery times for OpenFlow statistics and delete operations. For example, one statistical query may want the number of packets a flow has from a specific table. Another query seeks the total byte size. This statistical information is tabulated per each packet and in response to a cache hit for particular rules that are each uniquely identified. Thus, the statistical information is tracked for each unique identifier. The aggregated statistical information is then reported up to userspace 510 on a periodic or asynchronous basis.

The unique identifiers facilitate statistics gathering and reporting. For example, a cache entry has one or more identifiers uniquely representing the flow table rule(s) that constitute the cache entry. Hence, the process that updates the statistics in the flow table knows exactly which flow table rule(s) to update when a flow cache entry is hit. In the absence of a unique flow rule identifier stored in connection with a cached rule, the process of finding impacted rules (i.e., a rule in the flow table(s) to be updated) is much more complex.

The aforementioned advantages of unique identifiers also pertain to deletion of a rule. When a flow command to delete a flow table rule is received from a controller, the userspace application(s) attempts to delete a corresponding flow cache entry. The deletion from flow cache is simplified by assigning one or more unique identifiers to each cached rule and storing the cache rule's identifier(s) in the flow table rule. Then, during the deletion of flow table rule, a list of impacted cached rules can be readily generated and the corresponding rules are deleted. In other words, the deletion process knows which cached rule to delete instead of inspecting at all cached rules to determine which one is a match. In absence of the unique identifiers, the process of finding impacted cached rules is also much more complicated.

Datapath circuitry 556 processes (e.g., forwarding, directing, tagging, modifying, handling, or conveying) the packet based on the active-flow information of the first 530, second 534, and third 540 flow caches so as to optimize a multi-table lookup process and facilitate the datapath function.

FIG. 5 shows that the datapath circuitry 556 includes a network processing unit (NPU), such as an NP-5 or NPS-400 available from Mellanox Technologies of Sunnyvale, Calif. A network processor is an integrated circuit which has a feature set specifically targeted at the networking application domain. Network processors are typically software programmable devices and would have generic characteristics similar to general purpose CPUs that are commonly used in many different types of equipment and products. The network processor of the datapath circuitry 556 is characterized by L2-L7 processing and stateful forwarding tasks including stateful load balancing, flow tracking and forwarding (i.e., distributing) hundreds of millions of individual flows, application layer (L7) deep packet inspection (DPI), in-line classification, packet modification, and specialty acceleration such as, e.g., cryptography, or other task-specific acceleration. The datapath circuitry 556 also raises exceptions for flows that do not match existing network processing rules by passing these flows. Accordingly, the hardware 520 facilitates hundreds of Gb/s throughput while checking data packets against configurable network processing rules to identify packets.

In other embodiments, the datapath circuitry 556 may include an application specific integrated circuit (ASIC) tailored for handling fastpath processing operations; a CPU, such as an x86 processor available from Intel Corporation of Santa Clara, Calif., including side car or in-line acceleration; or another processing device.

In yet other embodiments, datapath circuitry is a microprocessor, microcontroller, logic circuitry, or the like, including associated electrical circuitry, which may include a computer-readable storage device such as non-volatile memory, static random access memory (RAM), DRAM, read-only memory (ROM), flash memory, or other computer-readable storage medium. The term circuitry may refer to, be part of, or include an ASIC, an electronic circuit, a processor (shared, dedicated, or group), or memory (shared, dedicated, or group) that executes one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

With reference to a multi-cache solution shown in FIG. 5, datapath functionality is defined according to the following pseudocode embodiment.

TABLE 3
Datapath Functionality

```
acl-match = match packet in access control flow cache;
if (acl-match) {
/* Packet metadata is information that can be optionally passed from one table to another
during the processing of a packet. Typically the packet metadata information
is not part of packet content itself. It is useful, for example, in tracking a state of a
flow. */
      collect actions, update packet metadata;
      optionally update statistics for all relevant OpenFlow rules;
      application-match = match packet in application flow cache;
      if (application-match) {
            collect actions, update packet metadata;
            optionally update statistics for all relevant OpenFlow rules;
            forward-match = match packet in forward flow cache;
            if (forward-match) {
                  optionally update statistics for all relevant OpenFlow rules;
                  apply actions and egress packet;
            }
            else {
/* If the packet is matched in access control and application caches but did not
match in the forward cache, this fact is reported to the application(s) managing the
flow tables and the cache-previously described as userspace application(s). This
information is reported because, e.g., the application(s) can recognize that they may
update the forward cache and not others. Otherwise, it may inadvertently add
duplicitous rules in the other caches. */
                  send packet as exception to userspace with flow cache match
                  entries from access control and application flow caches;
            }
      }
      else {
            send packet as exception to userspace with flow cache match entries
            in access control flow caches;
      }
}
else {
      send packet as exception to userspace.
}
```

The pseudocode of Table 3 represents software, firmware, or other programmable rules or hardcoded logic operations that may include or be realized by any type of computer instruction or computer-executable code located within, on, or embodied by a non-transitory computer-readable storage medium. Thus, the medium may contain instructions that, when executed by a processor or logic circuitry, configure the processor or logic circuitry to perform any method described in this disclosure. For example, once actions are obtained from cache, a processor may apply the actions by carrying out the specific instructions of the actions such as removing headers, simply forwarding a packet, or other actions preparatory to egressing the packet. Egressing the packet means to block, report, convey the packet, or configure another network interface to do so. Moreover, instructions may, for instance, comprise one or more physical or logical blocks of computer instructions, which may be organized as a routine, program, object, component, data structure, text file, or other instruction set, which facilitates one or more tasks or implements particular data structures. In certain embodiments, a particular programmable rule or hardcoded logic operation may comprise distributed instructions stored in different locations of a computer-readable storage medium, which together implement the described functionality. Indeed, a programmable rule or hardcoded logic operation may comprise a single instruction or many instructions, and may be distributed over several different code segments, among different programs, and across several computer-readable storage media. Some embodiments may be practiced in a distributed computing environment where tasks are performed by a remote processing device linked through a communications network.

Skilled persons will understand that many changes may be made to the details of the above-described embodiments without departing from the underlying principles of the invention. For example, although OpenFlow rules, tables, and pipelines are discussed as examples, other non-OpenFlow paradigms are also applicable. The scope of the present invention should, therefore, be determined only by the following claims.

1. A computer networking device for software-defined networking (SDN) that is administrable with a control plane protocol, the computer networking device comprising:
a memory to store multiple flow tables for handling a packet according to a datapath function configurable through the control plane protocol, the multiple flow tables including a pipeline of first, second, and third flow tables, the first flow table including first rules of different priorities, the second flow table including second rules sharing a common priority, and the third flow table including third rules that are matchable based on a prefix of a field of the packet;
one or more caches including first, second, and third flow caches to store active-flow information of the first, second, and third flow tables, respectively; and
datapath circuitry to process the packet based on the active-flow information of the first, second, and third flow caches so as to optimize a multi-table lookup process and facilitate the datapath function.

2. The computer networking device of claim 1, in which the datapath circuitry comprises a network processing unit.

3. The computer networking device of claim 1, in which the datapath circuitry is configured to process the packet by modifying it according to actions associated with the active-flow information.

4. The computer networking device of claim 1, in which the one or more caches comprise a ternary content-addressable memory (TCAM) for storing one or more of the first, second, and third flow caches.

5. The computer networking device of claim 4, in which the first flow cache comprises the TCAM.

6. The computer networking device of claim 1, in which the second flow cache comprises a hash table.

7. The computer networking device of claim 1, in which the third flow cache comprises a trie data structure.

8. The computer networking device of claim 1, in which the control plane protocol comprises messages from a controller, and in which the messages are translated into rules and actions deployed in the first, second, and third flow tables.

9. The computer networking device of claim 1, in which the first, second, and third flow tables comprise, respectively, a first set of flow tables, a second set of flow tables, and a third set of flow tables.

10. A method of optimizing a multi-table lookup process, the method comprising:
storing in first, second, and third flow caches, respectfully, first, second, and third information obtained from corresponding flow tables, the first, second, and third information indicating actions to take for handling packets, and the first, second, and third flow caches being different from one another;
sequentially attempting to match a packet to the first, second, and third information; and
in response to the packet matching, applying the actions to egress the packet.

11. The method of claim 10, further comprising, in response to the packet not matching, passing the packet through the corresponding flow tables to obtain the first, second, and third information for storing in the first, second, and third flow caches and handling the packet.

12. The method of claim 10, further comprising, updating statistics in response to the packet matching.

13. The method of claim 10, in which the first information includes a unique identifier, and in which the method further comprises updating statistics associated with the unique identifier.

14. The method of claim 10, in which the second information includes a unique identifier, and in which the method further comprises updating statistics associated with the unique identifier.

15. The method of claim 10, in which the third information includes a unique identifier, and in which the method further comprises updating statistics associated with the unique identifier.

16. The method of claim 10, in which the first, second, and third information corresponds to information of active flows.

17. The method of claim 10, in which the first flow cache corresponds to one or more flow tables having rules of different priorities.

18. The method of claim 10, in which the second flow cache corresponds to one or more flow tables having rules of a single priority.

19. The method of claim 10, in which the third flow cache corresponds to one flow table having rules that are matchable based on a prefix of a field of the packet.

20. The method of claim 10, further comprising revalidating the first flow cache while maintaining the second and third flow caches.

21. The method of claim 10, further comprising:
storing a unique identifier for a cached rule corresponding to the first information; and
deleting the cached rule in response to a command including the unique identifier.
